(19) United States
(12) Patent Application Publication
(10) Pub. No.: US 2018/0046268 A1
(43) Pub. Date: Feb. 15, 2018

(54) Multi-Transmitter Stylus Tip

(71) Applicant: Microsoft Technology Licensing, LLC, Redmond, WA (US)

(72) Inventors: Itay Keidar, Kfar-Saba (IL); David Frank Albert Rolland, Netanya (IL); Berty Albert Roza, Bat-Yam (IL)

(73) Assignee: Microsoft Technology Licensing, LLC, Redmond, WA (US)

(21) Appl. No.: 15/232,604

(22) Filed: Aug. 9, 2016

(51) Int. Cl. G06F 3/038; G06F 3/041; G06F 3/0354

(52) U.S. Cl. CPC G06F 3/0383; G06F 3/03545; G06F 3/0416; G06F 2203/04108; G06F 2203/04104

(57) ABSTRACT

Multi-transmitter stylus tip techniques are described herein. In implementations, a stylus employs a tip having an array of transmitters designed to can convey information regarding the shape, size, and position of the tip in three-dimensional space. The array of transmitters may be arranged in groups or layers disposed at different levels in relation to a three-dimensional volume of the tip. In implementations, the tip is configured as a brush head having a plurality of flexible bristles. In this approach, the array of transmitters may be spread across the bristles to represent or “map” the shape of the brush. A tip may be implemented as an integrated tip that is fixed to a stylus or as an interchangeable tip that is removably coupled to a stylus via an interface and interchangeable with a set of different tips supported by the stylus.

### BACKGROUND

Functionality that is available from various kinds of computing devices (e.g., mobile devices, game consoles, televisions, set-top boxes, personal computers, etc.) is ever increasing. Additionally, the techniques that may be employed to interact with the computing devices are also developing and adapting. For example, users traditionally interacted with computing devices using keyboards and a mouse. The keyboard was typically used to enter text whereas the mouse was used to control a cursor to navigate through a user interface of the computing device as well as initiate to actions, e.g., launching applications and so on. Additional techniques were subsequently developed, such as through support of a stylus to input digital handwriting, navigate through user interfaces, and so on.

Traditionally, interaction between a computing device and stylus occurs through a tip of a stylus. The tip of a conventional stylus is configured to mimic the finger of a user and is recognized as touch input by a digitizer. In this approach, the stylus is passive and is handled just like other touch input. An active stylus may include a tip transmitter device operable to communicate signals used to facilitate stylus location, pressure indications, and other advanced function.

### SUMMARY

Multi-transmitter stylus tip techniques are described herein. In implementations, a stylus employs a tip having an array of transmitters designed to convey information regarding the shape, size, and position of the tip in three-dimensional space. The array of transmitters may be arranged in groups or layers disposed at different levels in relation to a three-dimensional volume of the tip. In implementations, the tip is configured as a brush head having a plurality of flexible bristles. In this approach, the array of transmitters may be spread across the bristles to represent or “map” the shape of the brush. A tip may be implemented as an integrated tip that is fixed to a stylus or as an interchangeable tip that is removably coupled to a stylus via an interface and interchangeable with a set of different tips supported by the stylus.

Signals communicated from the array of transmitters are detectable by a computing device/digitizer to individually enumerate the transmitters, determine positions of the transmitters relative to the computing device/digitizer, and control device operations in accordance with the determined positions. The array of transmitters can also be configured to divide the tip in multiple discrete regions or zones that may be individually associated with different operations, properties, actions and behaviors. Thus, multiple different edges and surfaces of the tip are activated and available to use for advanced interaction scenarios. In a painting context for example, different regions may be associated with different colors of paint which may be transferred to and blended on a digital canvas based on manipulation of the stylus and corresponding positions of the transmitters. In implementations, light emitting elements such as LEDs are also employed to selectively illuminate the tip and provide visual representations of colors assigned to different regions of the tip.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques described herein.

FIG. 2 depicts an example configuration of a stylus that make use of a tip with an array of transmitters in accordance with one or more implementations.

FIG. 3 depicts an example interface for a stylus having an arrangement of connectors for coupling to interchangeable tips to in accordance with one or more implementations.

FIG. 4 depicts a tip for stylus as having an example configuration for an array of transmitters in accordance with one or more implementations.

FIG. 5 is a diagram representing use of a stylus having an array of transmitters in accordance with one or more implementations.

FIG. 6 is a diagram representing an example collection of interchangeable brush heads that may be supported by a stylus in accordance with one or more implementations.

FIG. 7 is a diagram depicting use of light emitting elements to illuminate regions of a tip in accordance with one or more implementations.

FIG. 8 is a flow diagram depicting an example procedure in which a stylus tip having an array of transmitters is used to drive corresponding actions in accordance with one or more implementations.

FIG. 9 is a flow diagram depicting an example procedure in which light emitting elements are employed to selectively illuminate a tip of a stylus in accordance with one or more implementations.

FIG. 10 illustrates various components of an example system that can implement aspects of the techniques described herein in accordance with one or more implementations.

### DETAILED DESCRIPTION

Designs for both passive and active styluses rely primarily upon the tip and/or single tip transmitter as an interaction point for device input. Stylus designs and interactions largely ignore the shape of the tip as well as various corresponding surfaces and edges. Consequently, the types of interactions and scenarios supported by traditional stylus designs are limited.

Multi-transmitter stylus tip techniques are described herein. In implementations, a stylus employs a tip having an array of transmitters designed to convey information regarding the shape, size, and position of the tip in three-dimensional space. The array of transmitters may be arranged in groups or layers disposed at different levels in relation to a three-dimensional volume of the tip. In implementations, the tip is configured as a brush head having a plurality of flexible bristles. The brush head may be designed to facilitate and improve painting operations in the context of digital content creation via an application of a computing device. In this approach, the array of transmitters may be spread across the bristles to represent or “map” the shape of the brush. A tip may be implemented as an integrated tip that is fixed to a stylus or as an interchangeable tip that is removably coupled to a stylus via an interface and interchangeable with a set of different tips supported by the stylus.

Signals communicated from the array of transmitters are detectable by a computing device/digitizer to individually enumerate the transmitters, determine positions of the transmitters relative to the computing device/digitizer, and control device operations in accordance with the determined positions. In implementations, a controller for the stylus is configured to generate multiple signals for transmission via the transmitters. Signals for different transmitters may have different properties such as different frequencies, patterns, strengths, and so forth.

The array of transmitters can also be configured to divide the tip in multiple discrete regions or zones that may be individually associated with different operations, properties, actions and behaviors. Thus, multiple different edges and surfaces of the tip are activated and available to use for advanced interaction scenarios. In a painting context for example, different regions may be associated with different colors of paint which may be transferred and blended based on manipulation of the stylus and corresponding positions of the transmitters. In implementations, light emitting elements such as LEDs are also employed to illuminate the tip to indicate different operations, properties, actions and behaviors. For example, LEDs associated with different regions may be controlled to provide visual representations of colors assigned to different regions of the tip in connection with painting operations.

Multi-transmitter stylus brush techniques as described herein improve information regarding the shape, size, and position of a stylus tip and consequently expand the types of interaction scenarios that are available. The techniques make it possible to understand shape and positioning of the stylus in three-dimensional space rather than relying solely upon touch indications and pressure applied to a digitizer surface. The techniques may also be employed to support a diverse set of interchangeable tips having different properties including but not limited to a collection of brush heads of varying sizes and shapes that may be used in a digital painting environment to mimic behaviors of real world brushes.

In the following discussion, an example environment is first described that is operable to employ the techniques described herein. Example illustrations of the techniques and procedures are then described, which may be employed in the example environment as well as in other environments. Accordingly, the example environment is not limited to performing the example techniques and procedures. Likewise, the example techniques and procedures are not limited to implementation in the example environment.

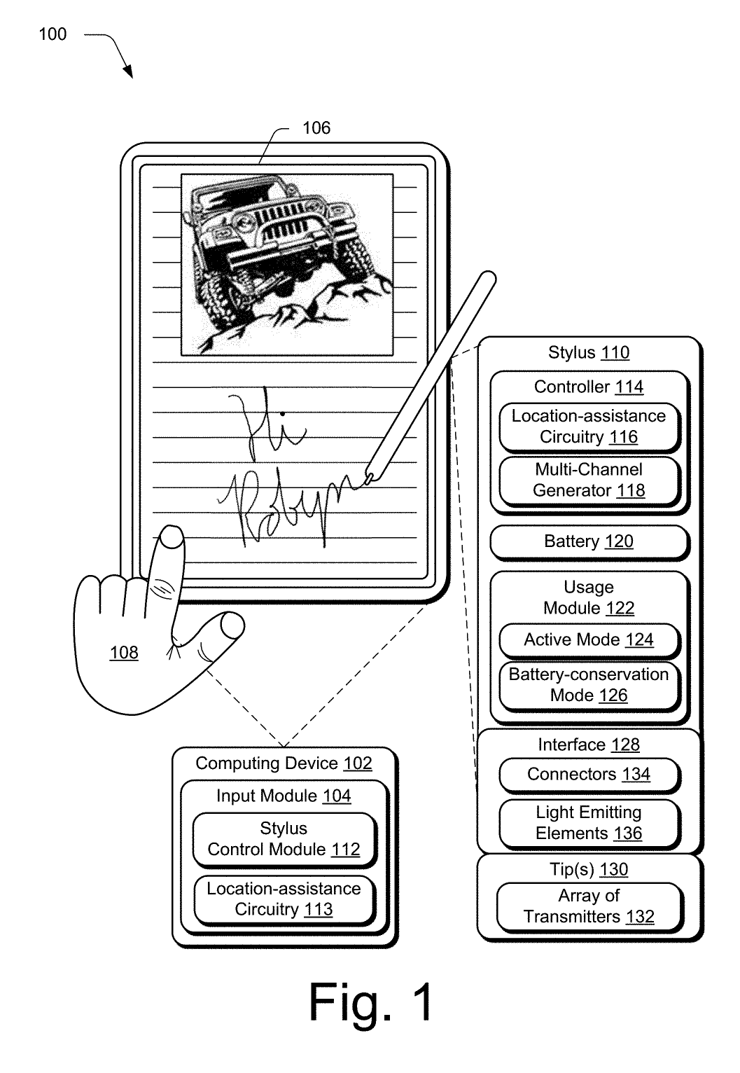

FIG. 1 is an illustration of an environment 100 in an example implementation that is operable to employ stylus techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including an input module 104. The input module 104 is representative of functionality relating to inputs of the computing device 102. For example, the input module 104 may be configured to receive inputs from a keyboard, mouse, to identify gestures and cause operations to be performed that correspond to the gestures, and so on. The inputs may be identified by the input module 104 in a variety of different ways.

For example, the input module 104 may be configured to recognize an input received via touchscreen functionality of a display device 106, such as a digitizer panel. The input module 104 may operate to detect a finger of a user's hand 108 as contacting of being within a threshold distance/proximity to the display device 106 of the computing device 102, recognize and resolve input provide via a stylus 110, and so on. The input may take a variety of different forms, such as to recognize movement of the stylus 110 and/or a finger of the user's hand 108 across the display device 106, pressing and tapping on the digitizer panel, drawing of a line, and so on. In implementations, various inputs may be recognized as gestures.

A variety of different types of gestures may be recognized, such a gestures that are recognized from a single type of input (e.g., touch gestures) as well as gestures involving multiple types of inputs. For example, the computing device 102 may be configured to detect and differentiate between a touch input (e.g., provided by one or more fingers of the user's hand 108) and a stylus input (e.g., provided by a stylus 110). The differentiation may be performed in a variety of ways, such as by detecting an amount of the display device 106 that is contacted by the finger of the user's hand 108 versus an amount of the display device 106 that is contacted by the stylus 110. Differentiation may also be performed through use of a camera to distinguish a touch input (e.g., holding up one or more fingers) from a stylus input (e.g., holding two fingers together to indicate a point) in a natural user interface (NUI).

Thus, the input module 104 may support a variety of different gesture techniques by recognizing and leveraging a division between stylus and touch inputs. For instance, the input module 104 may be configured to recognize the stylus as a writing tool, whereas touch is employed to manipulate objects displayed by the display device 108. Consequently, the combination of touch and stylus inputs may serve as a basis to indicate a variety of different gestures. For instance, primitives of touch (e.g., tap, hold, two-finger hold, grab, cross, pinch, hand or finger postures, and so on) and stylus (e.g., tap, hold-and-drag-off, drag-into, cross, stroke) may be composed to create a space involving a plurality of gestures. It should be noted that by differentiating between stylus and touch inputs, the number of gestures that are made possible by each of these inputs alone is also increased. For example, although the movements may be the same, different gestures (or different parameters to analogous commands) may be indicated using touch inputs versus stylus inputs.

The computing device 102 is further illustrated as including a stylus control module 112. The stylus control module 112 is representative of functionality of the computing device relating to operation of the stylus 110 and processing of input obtained via the stylus. For example, the stylus control module 112 may be configured to perform one or more actions responsive to the stylus 110, such as to draw lines as illustrated by the handwritten freeform lines in the display device 106 that illustrate “Hi” and “Robyn.” Computing device 102 may additionally include or makes use of location-assistance circuitry 113 to aid the stylus control module 112 in determining an XY location of the stylus 110 in relation to the display device 106.

Thus, the stylus control module 112 may be further configured to perform a variety of different operations, such as to draw a line to mimic a pencil or pen, produce strokes like a paintbrush, and so on. The stylus control module 112 may also recognize the stylus 110 to perform erase operations, such as to mimic a rubber eraser and erase portions of a user interface. Thus, the stylus control module 112 additionally provides interaction via the stylus 110 that is intuitive and natural to a user.

In accordance with techniques described herein, the stylus control module 112 is further configured to recognize the stylus and resolve positions of a tip portion and body of the user relative to the computing device. In implementations, stylus recognition and position resolution are based on analysis of signal patterns or “signatures” derived from signals communicated via by the stylus. Signatures can be mapped to different contexts including different interaction modes, stylus positions, hand positions, user positions, and scenarios. Accordingly, the stylus control module 112 can recognize different signal patterns and match the different signal signatures to corresponding contexts.

The stylus control module 112 further operates provide commands, messages, and/or control signals to direct operation of the computing device and stylus to selectively make adaptations and trigger actions in dependence upon recognized signal signatures and contexts. Directing operations includes, but is not limited to, adapting the user interface, causing the stylus to switch between modes, launching or closing applications, rendering results of input, triggering actions linked to gestures, providing feedback communication(s) to the stylus, resolving and correcting stylus position, computing stylus and/or hand hovering, hover height awareness, and scenario-based compensation for palm/hand interference.

As further depicted in FIG. 1, the stylus 110 may include a controller 114. The controller 114 represents logic, hardware, and circuitry of the stylus that implements various functionality associate with the stylus such as to power and control the stylus, establish communication channels, and exchange communications/data with other devices. The controller 114 may be implemented using various processing devices or systems such as an application-specific integrated circuit (ASIC), a general purpose processor or microcontroller, or a system on chip (SoC) device.

In an implementation, controller 114 includes location-assistance circuitry 116 to aid the stylus control module 112 in determining an XY location of the stylus 110 in relation to the display device 106. The location-assistance circuitry 116 may operate in conjunction with location-assistance circuitry 113 implemented via the computing device 102 to implement location determinations. Alternatively, the location-assistance circuitry 116 may be employed in lieu of location-assistance circuitry 113 to supply location data for processing by the stylus control module 112.

In an implementation, the circuitry associated with the controller 114 may also include a multi-channel generator 118 to support communication with the stylus control module 112, such as to generate multiple signals for transmission to a device via an array or transmitters as described above and below. The multi-channel generator 118 is operable to produce signals for different transmitters that have different properties such as different frequencies, patterns, strengths, and so forth. To power the controller, circuitry, and other components, the stylus 110 includes a battery 120.

The stylus 110 is further illustrated as including a usage module 122. The usage module 122 is representative of functionality of the stylus 110 to enter different usage modes. Although, illustrated separately, the usage module 122 may be integrated with the controller 114. For example, the usage module 122 may support an active mode 124 in which circuitry of the stylus 110 is made active and therefore permitted to consume power from the battery 120. Thus, the circuitry is available for use, such as to assist in providing signals, communication and/or an XY location to the computing device 102 and for receiving and processing data conveyed from the computing device 102 to the stylus 110.

The usage module 122 may also support a battery-conservation module 126 to conserve power of the battery 120, such as to make circuitry such as the location-assistance circuitry 116, the multi-channel generator 118, and so on inactive to minimize consumption of the battery 120. In this way, the usage module 122 may enter a low power state and conserve resources of the battery 120 yet enable functionality of the circuitry at appropriate times

To implement multi-transmitter stylus tip techniques as described herein, the stylus 110 may further include an interface 128 for coupling of the stylus 110 to one or more different tips 130. The tip(s) 130 may include an array of transmitters 132. As noted, the array of transmitters 132 is configured to convey information regarding the shape, size, and position of the tip in three-dimensional space. For example, the array of transmitters may be arranged in groups or layers disposed at different levels in relation to a three-dimensional volume of the tip as discussed in greater detail below.

The interface 128 is configured to physically and communicatively couple the circuitry of the stylus to a tip 130. To do so, the interface 128 includes an arrangement of multiple connectors 134. The connectors 134 are connectable to the array of transmitters 132 disposed in the tip. Connectors 134 may be configured as a set of elements effective to establish the physical and communicative coupling between the housing for the stylus 110 and a tip 130.

Generally, the connectors 134 mate with complimentary elements of the tip. For example, the connectors 134 may be configured as an arrangement of pins, strips, slots, and/or tab elements designed to connect to corresponding elements associated with a tip. In this way, signals generated via the controller 114 and/or multi-channel generator 118 may be conveyed to the array of transmitters 132 for transmission to enable detection and enumeration of the stylus by a host system (e.g., computing device 102 and/or digitizer).

Various configurations of connectors 134 and couplings between a stylus housing and tip are contemplated. In one approach, a tip may be implemented as an integrated tip that is fixed via the connectors 134 to the stylus. In another approach the interface 128 is designed to provide a standardized arrangement of connectors that may support removable and interchangeable tips. In this case, the tip is removably coupled via an interface 128 and interchangeable with a set of interchangeable tips supported by the stylus. Some further details and examples regarding configurations of connectors 134 are discussed below in relation to FIG. 3.

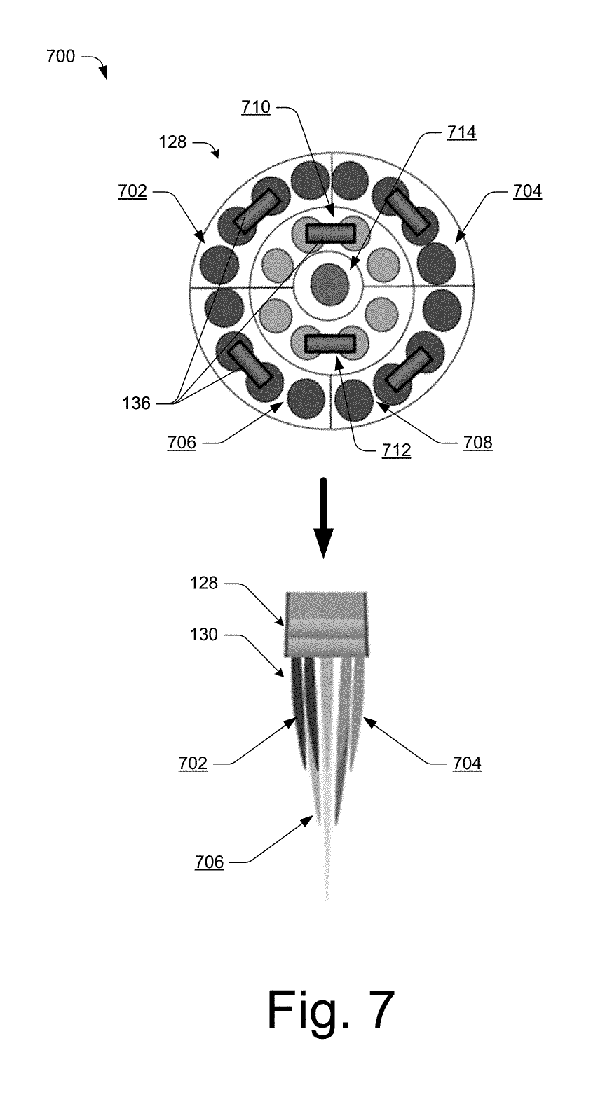

The interface 128 may further include light emitting elements 136. Light emitting elements 136 may be configured as LEDs or other suitable light elements. As noted, light emitting elements 136 may be employed to illuminate the tip to indicate different operations, properties, actions and behaviors. For example, light emitting elements 136 may be associated with different regions of the tip and may be selectively illuminated in different colors in dependence upon a current state of the stylus and/or individual regions. In one particular example, the light emitting elements 136 may be used to provide representations of paint colors associated with different portions of a tip in the form of a brush head. Some further details and examples regarding configurations and use of light emitting elements 136 are discussed below in relation to FIG. 7.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the stylus mode techniques described below are platform-independent, meaning that the techniques may be implemented on a variety of commercial computing platforms having a variety of processors.

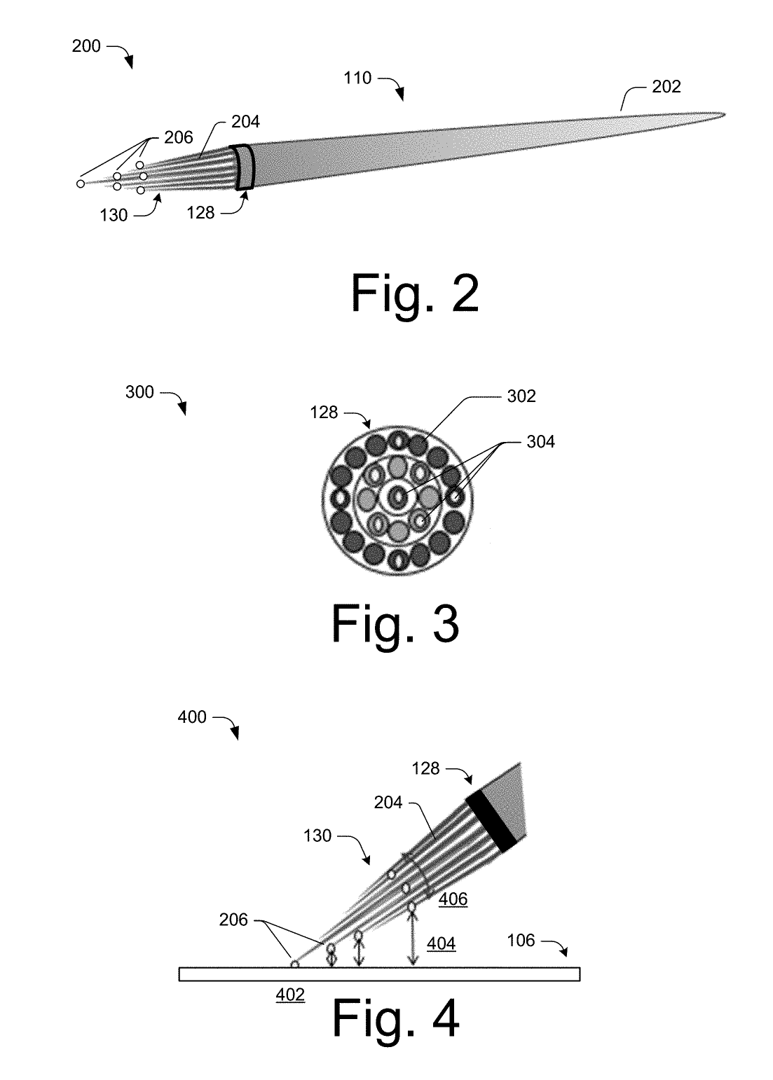

FIG. 2 depicts generally at 200 an example configuration of a stylus 110 of FIG. 1 that makes use of a tip with an array of transmitters in accordance with one or more implementations. The stylus 110 is configured to include a housing portion 202 that is coupled to a tip 130 via an interface 128. The tip 130 may be configured in various ways such as having a rounded end to mimic a finger, a pointed element to form a writing instrument, a brush head, and so forth. In this example, the tip 130 is represented as a brush 204 having a plurality of flexible bristles. The flexible bristles may be made from fiber, plastic, natural and/or composite material design to flex and deform like a paintbrush.

The tip 130 also includes an array of transmitters 132, which may be configured in various ways. The array of transmitters 132 includes a plurality of detectable points 206 indicated by representative circles disposed at particular locations throughout the tip. Generally, the array of transmitters 132 is arranged across to tip such that the detectable points 206 represent and may be used to convey information regarding the shape, size, and position of the tip in three-dimensional space. In other words, the detectable points 206 are physically arranged to correspond to the shape of the tip and enable a logical map of the tip to be defined. For instance, the detectable points 206 in the example of FIG. 2 have a conical arrangement that represents a shape of the brush 204. Here, the detectable points 206 are located as endpoints of designated bristles for the brush 204.

In general, the detectable points 206 correspond to multiple locations at which signals are transmitted from the tip for detection by the digitizer/device. The signals may be produced via a controller 114 and/or multi-channel generator 118 of the stylus as previously noted. In one or more implementations, the detectable points 206 are configured to form closed loop communication channels when the points are in contact with or within a threshold distance from the surface of the digitizer/device. Such communication channels may be established using capacitive touch capabilities of the digitizer. In this context, the detectable points 206 may correspond to locations designed to transmit signals that are recognizable using the capacitive touch features. The techniques described herein may also rely upon other kinds of communication technology such as using RF transmitters/receivers, optical sensors, signal with various patterns and properties, and so forth.

The array of transmitters 132 formed via the detectable points 206 can divide the tip into multiple discrete regions or zones. The multiple discrete regions are created by arranging the detectable points 206 in groups or layers. The groups or layers may be disposed at different levels in relation to a three-dimensional volume of the tip. For instance, groups of detectable points may be defined based on position or depth along a longitudinal axis of the tip/stylus relative to a reference location, such as one end of the tip, the connector side of the tip, and so forth. Zones or regions may also be established based upon the circumferential or rotational position around the tip, such that different surfaces around the body of the tip may be divided into different discrete regions or zones. These discrete regions or zones may be individually associated with different operations, properties, actions, and behaviors. Thus, multiple different edges and surfaces of the tip may be activated and available to use for advanced interaction scenarios.

The array of transmitters 132 corresponds to and is connected to circuitry of the stylus via an arrangement of connectors 134 provide via the interface 128. In this context, consider FIG. 3 which depicts generally at 300 an example interface 128 for a stylus having an example arrangement of connectors in accordance with one or more implementations. As noted, the interface 128 is configured to physically and communicatively couple the circuitry of the stylus to a tip 130. More particularly, the connectors 134 of the interface establish connections between the detectable points 206 and the controller 114/circuitry of the stylus 110. The interface 128 may provide a fixed connection for an integrated tip (e.g., tip that cannot be removed or replaced). Alternatively, the interface 128 may be configured to provide a standardized arrangement of connectors that may support removable and interchangeable tips. In this case, the tip is removably coupled via an interface 128 and interchangeable with a set of interchangeable tips supported by the stylus, such as a plurality of different brush heads as described in this document.

Connectors 134 may be configured in various ways to mate with complimentary elements of the tip 130. By way of example, the connectors 134 may be formed as electrical contacts in the form of pin slots that are designed to accept corresponding pins of the tip 130, or vice versa. Other elements and combinations of different types of elements are also contemplated such as contact strips, magnetic coupling devices, tabs, sockets and so forth. These and other contact and attachment elements may be used individually or in various combinations to secure the tip to the housing and create a communicative coupling.

In the represented example of FIG. 3, an end-on view of the stylus 110 is depicted showing the interface 128 without an attached tip 130 and thereby revealing the underlying arrangement of connectors 134. In this example, the arrangement of connectors 134 includes both inactive elements 302 represented by solid circles and active elements 304 represented by open circles. For a tip in the form of a brush, the elements correspond to bristles of the brush with the active elements 304 being connected to detectable points 206 disposed on particular bristles and the inactive elements 302 being associated with bristles that lack the detectable points 206.

The arrangement of connectors 134 also includes different groups or zones. These groups or zones of the connectors define the different groups or zones for the tip. In other words, it is the arrangement of multiple connectors in the interface that is configured to logically divide the tip portion into multiple discrete regions thereby enabling assignment of different properties and behaviors to the multiple discrete regions on a region by region basis. The arrangement may also provide a standard model to support different types of interchangeable tips and brushes using an established pattern for the connectors and detectable points used to represent the tip properties (e.g., shape, size, type, regions, etc.).

In this example, the connectors 134 are arranged in concentric circles. The connectors 134 arranged in the concentric circles can be mapped to the detectable points 206 shown in FIG. 2 that are located at different depths for the brush 204. For example, the inner most circle corresponds to the very tip of the brush, the middle circle maps to the middle layer of detectable points 206, and the outer circle has connectors 134 for the outer layer of detectable points 206 (e.g., layer closest to the connector.). In this example, a total of eight active elements 304 is employed. However, the number of elements used may increase or decrease based on considerations such as end-use, cost, precision of the stylus, tip shapes, and so forth. Here, the concentric circles also correspond to bristles of the example brush 204 that have different lengths, with the inner most bristle being the longest and the bristles getting shorter moving outward from the center and along the longitudinal axis of tip towards the interface 128. While a concentric arrangement is illustrated, other patterns for connectors and correlations of the connectors to different elements, components, and surfaces of a tip are also contemplated.

FIG. 4 depicts generally at 400 a tip for stylus 110 as having an example configuration for an array of transmitters 132 in accordance with one or more implementations. In particular, the example of FIG. 4 represents operation of the stylus 110 and detection of array the transmitters 132 through interaction with a display device 106. For instance, signals communicated via the detectable points 206 are picked up by the digitizer of the display device 106. The signals may be processed and interpreted by the stylus control module 112 (or comparable functionality) to identify the tip, enumerate the different transmitters, and resolve the position of the tip and stylus relative to the display device 106 in three-dimensional space.

In this example, the detectable points 206 are associated with the ends of bristles for a brush 204 as previously described. Processing of the signals enables detection and location of the detectable points 206 on an individual basis. This includes ascertaining points of contact 402 with the display, distances of the detectable points 206 from the display as represented by arrows 404, and orientation/rotation of the tip based on positions of the detectable points 206 relative to one another as indicated by the curved arrow 406. Points of contact indicate which parts and regions of the tip are touching the display. The distances may provide indications of hovering position, stylus movement and gestures, tilt angle and position of the stylus relative to the display, and so forth. The positions of the detectable points 206 relative to one another indicate the rotational position of the tip, shape of the tip/brush, deformation of the tip due to strokes, presses, and other manipulations, and further information regarding the position and movements of the stylus.

The detectable points 206 may be individually enumerated via corresponding signals that are generated by the controller 114 and conveyed via the transmitters. Signals for different detectable points 206 may have different characteristics as previously noted. The detectable points 206 may also be assigned different identifiers or names that facilitate tracking of the detectable points 206 and position of the detectable points relative to the display and relative to one another. The identifiers or names for the detectable points 206 are also used to individually address the detectable points 206, which can be employed to assign different actions, properties and behaviors to different points; divide the tip into regions; and otherwise drive operations differently for different points on the tip.

Accordingly, the detectable points 206 enable the system to understand and utilize the three dimensional shape of the tip and the positional relationship of the tip in three-dimensional space relative to the display to drive corresponding actions. Further, the system can distinguish between different regions of the tip and control actions and behaviors on a region-by-region basis. As but one example, when used with a color palette of a painting programs, different parts of the tip/brush that touch different colors may pick-up different colors of paint accordingly. Then, when the tip/brush is used to paint on a digital canvas, the paint may be applied and mixed according to manipulation of the stylus that causes different portions of the tip to contact the display. This provides a realistic digital painting experience that closely matches real-world painting.

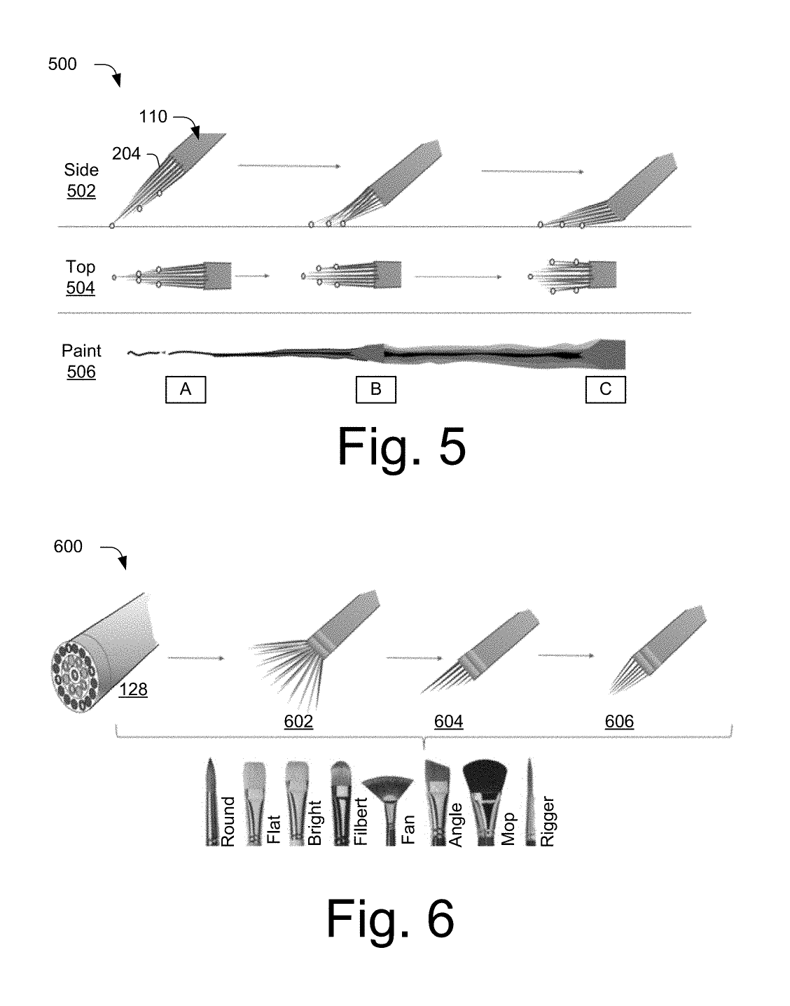

FIG. 5 is a diagram representing generally at 500 use of a stylus having an array of transmitters in accordance with one or more implementations. The example sequence depicted shows a side view 502 and top view 504 of a stroke of the stylus 110 across a display device 106 from stage A, to stage B, and then to stage C. Here, the stylus 110 is again represented as having a tip 130 configured as a brush 204 that may facilitate painting operations in connection with a suitably configured application. Accordingly, the example sequence also represents a trail of paint 506 that may be generated and rendered in response to the illustrated stroke.

Notice that as the stroke progresses in the sequence from A to C, the brush is being pressed into and dragged across the surface of the display/digitizer. Initially at A, just the very end of the tip is in contact with the surface, and thereafter the flexible bristles are pushed down and spread out due to manipulation of the stylus 110. Positions of detectable points 206 that form the array of transmitters for the brush 204 are correspondingly altered based on the manipulation.

As can be seen in the side view 502, additional detectable points 206 come in contact with the surface as the brush 204 deforms. Likewise, the top view 504 illustrates that the detectable points 206 spread out along with corresponding bristles as the brush 204 fans out in response to the stroke. Tracking of the detectable points 206 during strokes as in the depicted example and other manipulations of the stylus 110 enable the system to resolve the tip/detectable point positions and recognize changes to the size and shape of the tip that occur due to the manipulations.

Operations can be selectively implemented based on analysis and interpretation of the detectable points 206 and corresponding signals. For example, in the context of painting operations, a trail of paint 506 may be output in response to the example stroke shown in FIG. 5. In this case, the trail of paint 506 starts as a narrow line at A and then fans out moving to B and then on to C. Moreover, as different points of the tip/brush come in contact with the display, the trail of paint 506 may reflect different colors of paint that are associated with the different points. Thus, the trail of paint 506 starts as a single color and then additional colors are added and may be mixed in to produce the output streak of color as the stroke progresses through B and C, the brush fans out, and additional detectable points 206 are placed in contact with the display. Again, this experience is very comparable to the way in which artists paint with paintbrushes in the real world.

FIG. 6 is a diagram depicting generally at 600 an example collection of interchangeable brush heads that may be supported by a stylus in accordance with one or more implementations. As noted, an interface 128 for a stylus 110 may be provided that is configured to physically and communicatively couple the circuitry of the stylus to a tip 130. The tip 130 may take various different forms including brush heads of different sizes and shapes. In implementations, the interface 128 supports interchangeable tips that may be removably connected to the stylus via the interface and interchanged one to another.

To illustrate, FIG. 6 depicts representative brushes 602, 604, and 608 that may be connected to the interface 128 at different times. The brushes may have various sizes and shapes, examples of which are further shown in FIG. 6. The particular shape of each brush may be represent by disposing detectable points 206 across the bristles to create a map of the brush shapes. The detectable points 206 correspond to a standardized pattern of connectors 134 include with the interface 128. Thus, an array of transmitters 132 that reflects the three-dimensional shape of the particular tip/brush is formed when the particular tip/brush is connected to the interface. This enable the stylus control module 112 or comparable functionality to identify and distinguish between different tips/brushes and resolve the position of the tips/brushes in accordance with techniques described herein.

FIG. 7 is a diagram depicting generally at 700 a scenario in which light emitting elements are employed to illuminate regions of a tip in accordance with one or more implementations. For example, an interface 128 may include an arrangement of light emitting elements 136 that may be configured in various ways as represented by the example of FIG. 7. The light emitting elements 136 may be configured as LEDs or other suitable light elements that are capable of illuminating regions of a tip 130. Different colors may be used at different times to indicate different states associated with different regions such as different operations, properties, actions and behaviors. Additionally, different colors may be used concurrently with different regions to show differences between the regions. This includes using different colors to represent different colors of paint associated with different regions of the tip 130 in a connection with an application that enables painting operations.

In the depicted example, a view of interface 128 is shown which includes connectors that are divided into different regions or groups. These different regions of the interface 128 are employed to divide a tip connected to the interface 128 into corresponding regions and/or layers. At least some of the regions may be associated with light emitting elements 136 that may be employed to selectively illuminate portions of the tip.

In this example, the interface 128 includes an outer ring of connectors that is divided into quadrants. The outer ring includes regions 702, 704, 706 and 708. A middle ring of connectors includes two additional regions 710 and 712. A further region 714 corresponds to the center most portion of the interface 128. In this example, light emitting elements 136 are associated with each of the regions in the outer ring and the middle ring. Naturally, various other configurations of light emitting elements 136 and regions are also contemplated. For example, light emitting elements 136 may be included for the outer ring and not the middle ring, or vice versa. Moreover, although not shown, the region 714 may include light emitting elements 136 in addition to or in lieu of elements in other regions. Further, the numbers of regions and light emitting elements 136 employed may vary and is not limited to the example numbers, arrangements, and positions shown.

FIG. 7 further illustrates a tip 130 having regions corresponding to those described for the interface 128. Here, the tip 130 is represented as having different colors associated with different regions. Thus, the tip 130 is represented as being illuminated by light emitting elements 136 in accordance with color assigned to different regions. In particular, regions 702 and 704 corresponding the outer ring are represented as being illuminated with different respective colors. Additionally, region 706 corresponding to the middle ring is represented as being illuminated in yet another different color. In this way, light emitting elements 136 may be used to provide visual representations of different paint colors that are “picked-up” by different portions of a tip/brush in a painting context. Comparable techniques may be employed in other contexts to provide visual representations of different states for different portions/surfaces of tip by illuminating the portions/surfaces to reflect the different states. Further details regarding these and other aspects are discussed in relation to the following example procedures.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

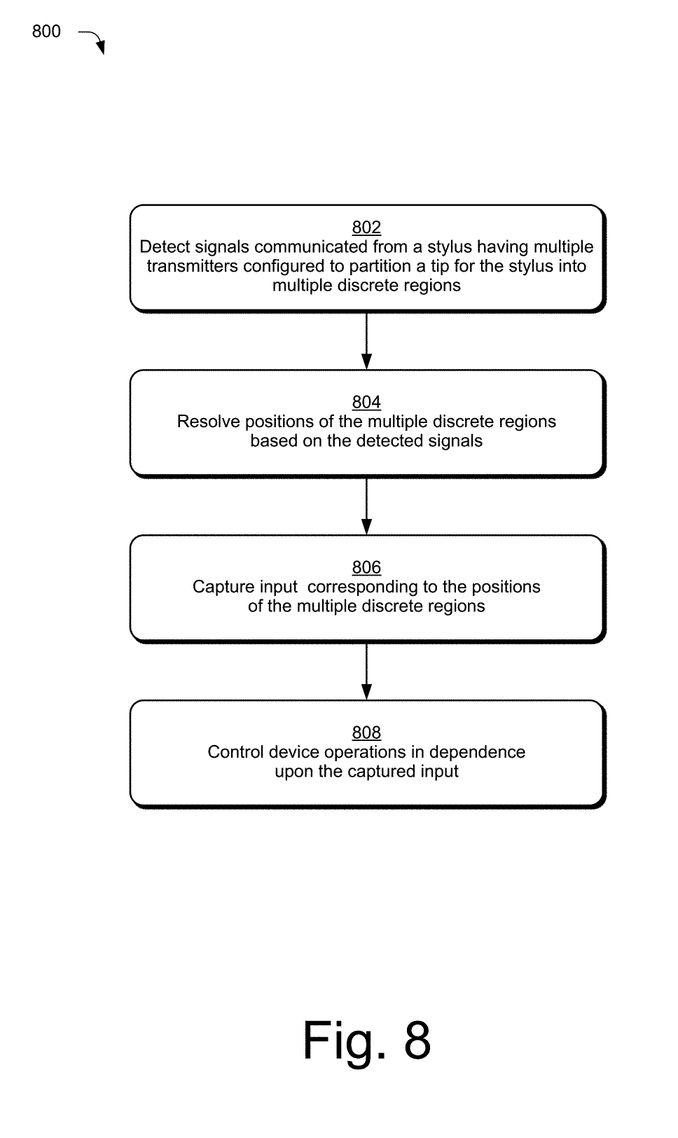

FIG. 8 is a flow diagram depicting an example procedure 800 in which a stylus tip having an array of transmitters is used to drive corresponding actions in accordance with one or more implementations. One or more signals are detected that are communicated from a stylus having multiple transmitters configured to partition a tip for the stylus into multiple discrete regions (block 802). For example, a computing device 102 may include functionality to detect and interpret signals transmitted by a stylus 110, such as stylus control module 112 or comparable functionality. The stylus 110 may be configured to implement a tip 130 having an array of transmitters 132. The array of transmitters 132 may include a plurality of individual detectable points 206 that are configured to divide the tip 130 into different regions as described herein. Signals generated via a controller 114 and/or a multi-channel generator 118 of the stylus are conveyed via the array of transmitters 132 for detection via a digitizer of a display device 106. The digitizer may include or invoke the stylus control module 112 or comparable functionality to process and interpret the signals.

Positions of the multiple discrete regions are resolved based on the detected signals (block 804) and input is captured corresponding to the positions of the multiple discrete regions (block 806). Then, device operations are controlled in dependence upon the captured input (block 808). For example, a stylus control module 112 or equivalent functionality may reference mapping data indicative of different known signatures for signals from a stylus 110. Here, a detected signal is compared against a database of defined patterns to match the detected signal to a known signature. In this case, the pattern of signals from the array of transmitters 132 may correlate to the identity of a tip, a position of the tip and stylus in three-dimensional space relative to the digitizer, defined gestures or contexts, and so forth. Input that is captured via the stylus is used to determine the current interaction scenario and to drive appropriate actions. For example, gestures input via the stylus may be recognized to cause corresponding actions assigned to the gestures. Gestures may be application and context specific.

In relation to an application that supports use of the stylus as a paintbrush, input indicative of paint selection may cause one or multiple colors of paint to be assigned to different regions of the tip. In this type of painting context, strokes, presses, and other manipulation of a stylus in relation to a digital canvas may cause logical transfer of paint from the tip to the canvas to produce an image or painting. As noted, different surfaces and regions of the tip may be individually addressed and utilized such that different operations, properties, actions and behaviors may be assigned to the different regions on an individual basis.

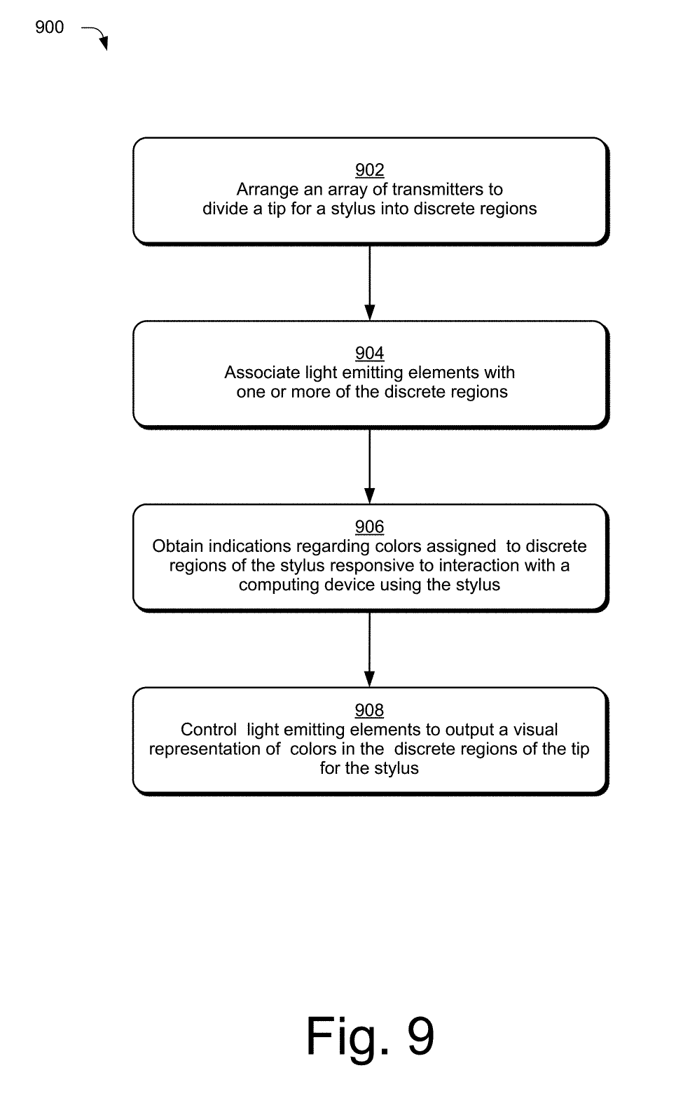

FIG. 9 is a flow diagram depicting an example procedure 900 in which light emitting elements are employed to selectively illuminate a tip of a stylus in accordance with one or more implementations. An array of transmitters is arranged to divide a tip for a stylus into discrete regions (block 902) and light emitting elements are associated with one or more of the discrete regions (block 904). For example, a stylus 110 may include an interface 128 and various detectable points 206 disposed in a tip 130 that are arranged to divide the tip into discrete regions as previously described. Moreover, the stylus 110 may include an arrangement of light emitting elements 136 that are incorporated with the interface 128 or otherwise positioned to selectively illuminate at least some of the discrete regions. For example, light emitting elements 136 may be arranged in various ways as discussed in relation to the examples of FIG. 7.

Indications regarding colors assigned to discrete regions of the stylus are obtained responsive to interaction with a computing device using the stylus (block 906) and the light emitting elements are controlled to output a visual representation of the colors assigned to the discrete regions established for the stylus (block 908). For example, a stylus 110 as described in this document may be employed to provide input in the context of various interaction scenarios and applications. Using an array of transmitters 132 and a plurality of detectable points 206, the stylus is able to convey information regarding the tip and position of the tip in three dimensions. This enables different regions and surfaces of the tip to be separately activated and utilized.

In particular, touching different elements to a selection control element may cause different states to be assigned to different regions. For example, a selection control element in the form of a color palette may be employed to assign different paint colors to different portions of a tip/brush. In another example, a control providing a set of editing operation such as cut, paste, copy, delete may be assigned to different regions of the tip by touching the different regions to representation of the operations. In yet another example, navigation options such as scroll, next page, pause, record, etc. may be assigned to different regions using a selection control element for the navigation options.

In each of these cases, the stylus may be subsequently used to trigger different actions associated with different regions by manipulating the stylus accordingly. Thus, different colors of paint may be transferred to a canvas in a painting context by touching different portions of the tip to the canvas. In a similar way, different editing operations or navigation options may be initiated by touching appropriate tip portions to the screen or otherwise activating different regions of the tip at different times.

Having considered the foregoing example environment, devices and techniques, consider not a discussion of an example system that may be utilized to implement various aspects in accordance with one or more implementations.

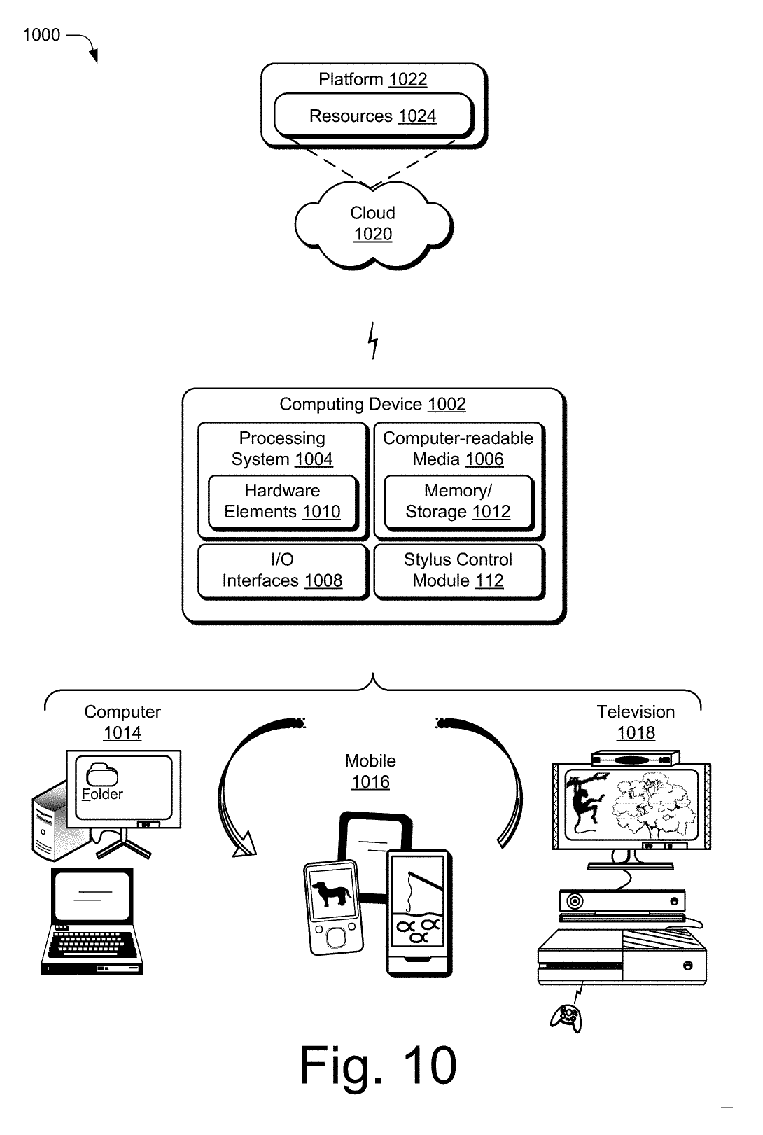

FIG. 10 illustrates an example system 1000 that includes an example computing device 1002 that is representative of one or more computing systems and/or devices that may implement the various techniques described herein. The computing device 1002 may be, for example, a server of a service provider, a device associated with a client (e.g., a client device), an on-chip system, and/or any other suitable computing device or computing system.

The example computing device 1002 as illustrated includes a processing system 1004, one or more computer-readable media 1006, and one or more I/O interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware elements 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a stylus, a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 1002, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the input module 104, stylus control module 112 and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules as a module that is executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, portable music player, portable gaming device, a tablet computer, a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. This is illustrated through inclusion of the stylus control module 112 with the computing device 1002. The functionality represented by the stylus control module 112 and other modules/applications may also be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

Example implementations of techniques described herein include, but are not limited to, one or any combinations of one or more of the following examples:

### Example 1

A stylus for a computing device comprising: a housing portion including circuitry to enable use of the stylus as an input device for the computing device; and an interface integrated with the housing portion configured to physically and communicatively couple the circuitry to a tip portion, the interface including an arrangement of multiple connectors connectable to an array of transmitters disposed in the tip portion, the array of transmitters positioned to represent a three-dimensional shape of tip portion.

### Example 2

A stylus as described in any one or more of the examples in this section, wherein the tip portion is configured as a brush having a plurality of flexible bristles.

### Example 3

A stylus as described in any one or more of the examples in this section, wherein the brush having the plurality of flexible bristles facilitates painting operations in conjunction with an application of the computing device.

### Example 4

A stylus as described in any one or more of the examples in this section, wherein the interface is configured to provide a removable coupling to the tip portion.

### Example 5

A stylus as described in any one or more of the examples in this section, wherein the arrangement of the multiple connectors in the interface enables coupling to a set of interchangeable tip portions supported by the stylus.

### Example 6

A stylus as described in any one or more of the examples in this section, wherein the set of interchangeable tip portions includes a plurality of different brush heads of varying sizes and shapes.

### Example 7

A stylus as described in any one or more of the examples in this section, wherein the arrangement of multiple connectors in the interface comprises groups of connectors disposed in a standardized pattern.

### Example 8

A stylus as described in any one or more of the examples in this section, wherein the different groups of connectors correspond to transmitters in the array of transmitters located at different depths along a longitudinal axis of the tip portion.

### Example 9

A stylus as described in any one or more of the examples in this section, wherein the interface is employed to convey signals from the stylus through the array of transmitters for detection via a digitizer of the computing device, the signals indicative of positions of the array of transmitters relative to the digitizer.

### Example 10

A stylus as described in any one or more of the examples in this section, further comprising a multi-channel generator to generate the signals conveyed via the interface to the tip portion for transmission through the array of transmitters for detection.

### Example 11

A stylus as described in any one or more of the examples in this section, wherein the multi-channel generator is configured to produce signals having different signal characteristics, such that two or more transmitters of the array of transmitters operate using different signal characteristics.

### Example 12

A stylus as described in any one or more of the examples in this section, wherein the arrangement of multiple connectors is configured to logically divide the tip portion into multiple discrete regions thereby enabling assignment of different properties to the multiple discrete regions on a region-by-region basis.

### Example 13

A stylus as described in any one or more of the examples in this section, wherein:

the tip portion comprises a brush having the plurality of flexible bristles to facilitate painting operations in conjunction with an application of the computing device; and

assignment of different properties to the multiple discrete regions comprises associating different colors of paint with at least two of the multiple discrete regions in connection with the painting operations.

### Example 14

A stylus as described in any one or more of the examples in this section, wherein the interface further comprises one or more light emitting elements configured to selectively illuminate one or more of the multiple discrete regions to visually represent colors of paint associated with the regions.

### Example 15

An apparatus comprising: a housing portion and a tip portion shaped to form a stylus operable as an input device for providing input to a computing device; an array of transmitters disposed in the tip portion, the array of transmitters positioned to represent a three-dimensional shape of tip portion; and a controller to generate signals for transmission through the array of transmitters, the signals for detection via a digitizer panel of the computing device to resolve positions of the array of transmitters relative to the digitizer panel in three-dimensional space and to control operations of the computing device in dependence upon the positions of the array of transmitters.

### Example 16

An apparatus as described in any one or more of the examples in this section, wherein the tip portion is an integrated component of the stylus.

### Example 17

An apparatus as described in any one or more of the examples in this section, wherein the tip portion is an interchangeable component of the stylus removably connected to the housing via an interface integrated with the housing portion, the interface configured to physically and communicatively couple different tip portions having different characteristics to the housing portion at different times.

### Example 18

A system comprising: a computing device having a display device including a digitizer panel; a stylus operable as an input device for providing input to the computing device via the digitizer panel, the stylus including a housing portion physically and communicatively coupled to a tip portion via an interface integrated with the housing portion, the housing portion including circuitry to enable communication with the digitizer panel, the interface including an arrangement of multiple connectors connectable to an array of transmitters disposed in the tip portion, and the tip portion configured as a brush with a plurality of flexible bristles to facilitate painting operations in conjunction with an application of the computing device and including the array of transmitters disposed in a three-dimensional arrangement across the plurality of flexible bristles to represent a three-dimensional shape of the brush.

### Example 19

A system as described in any one or more of the examples in this section, wherein the stylus further comprises one or more one or more light emitting elements configured to selectively illuminate regions of the brush to visually represent colors of paint associated with the regions in connection with the painting operations.

### Example 20

A system as described in any one or more of the examples in this section, wherein: the stylus includes a multi-channel generator to generate signals conveyed via the interface to the tip portion for transmission through the array of transmitters; and the computing device include a stylus control module operable to detect and interpret the signals to resolve positions of the array of transmitters relative to the digitizer panel in three-dimensional space, and to control the painting operations in dependence upon the positions of the array of transmitters.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A stylus for a computing device comprising:
a housing portion including circuitry to enable use of the stylus as an input device for the computing device; and
an interface integrated with the housing portion configured to physically and communicatively couple the circuitry to a tip portion, the interface including an arrangement of multiple connectors connectable to an array of transmitters disposed in the tip portion, the array of transmitters positioned to represent a three-dimensional shape of the tip portion.

2. A stylus as described in claim 1, wherein the tip portion is configured as a brush having a plurality of flexible bristles.

3. A stylus as described in claim 2, wherein the brush having the plurality of flexible bristles facilitates painting operations in conjunction with an application of the computing device.

4. A stylus as described in claim 1, wherein the interface is configured to provide a removable coupling to the tip portion.

5. A stylus as described in claim 1, wherein the arrangement of the multiple connectors in the interface enables coupling to a set of interchangeable tip portions supported by the stylus.

6. A stylus as described in claim 5, wherein the set of interchangeable tip portions includes a plurality of different brush heads of varying sizes and shapes.

7. A stylus as described in claim 1, wherein the arrangement of multiple connectors in the interface comprises groups of connectors disposed in a standardized pattern.

8. A stylus as described in claim 7, wherein different groups of connectors correspond to transmitters in the array of transmitters located at different depths along a longitudinal axis of the tip portion.

9. A stylus as described in claim 1, wherein the interface is employed to convey signals from the stylus through the array of transmitters for detection via a digitizer of the computing device, the signals indicative of positions of the array of transmitters relative to the digitizer.

10. A stylus as described in claim 9, further comprising a multi-channel generator to generate the signals conveyed via the interface to the tip portion for transmission through the array of transmitters for detection.

11. A stylus as described in claim 10, wherein the multi-channel generator is configured to produce signals having different signal characteristics, such that two or more transmitters of the array of transmitters operate using different signal characteristics.

12. A stylus as described in claim 1, wherein the arrangement of multiple connectors is configured to logically divide the tip portion into multiple discrete regions thereby enabling assignment of different properties to the multiple discrete regions on a region-by-region basis.

13. A stylus as described in claim 12, wherein:
the tip portion comprises a brush having the plurality of flexible bristles to facilitate painting operations in conjunction with an application of the computing device; and
assignment of different properties to the multiple discrete regions comprises associating different colors of paint with at least two of the multiple discrete regions in connection with the painting operations.

14. A stylus as described in claim 13, wherein the interface further comprises one or more light emitting elements configured to selectively illuminate one or more of the multiple discrete regions to visually represent colors of paint associated with the regions.

15. An apparatus comprising:
a housing portion and a tip portion shaped to form a stylus operable as an input device for providing input to a computing device;
an array of transmitters disposed in the tip portion, the array of transmitters positioned to represent a three-dimensional shape of the tip portion; and
a controller to generate signals for transmission through the array of transmitters, the signals for detection via a digitizer panel of the computing device to resolve positions of the array of transmitters relative to the digitizer panel in three-dimensional space and to control operations of the computing device in dependence upon the positions of the array of transmitters.

16. An apparatus as described in claim 15, wherein the tip portion is an integrated component of the stylus.

17. An apparatus as described in claim 15, wherein the tip portion is an interchangeable component of the stylus removably connected to the housing portion via an interface integrated with the housing portion, the interface configured to physically and communicatively couple different tip portions having different characteristics to the housing portion at different times.

18. A system comprising:
a computing device having a display device including a digitizer panel;
a stylus operable as an input device for providing input to the computing device via the digitizer panel, the stylus including a housing portion physically and communicatively coupled to a tip portion via an interface integrated with the housing portion,
the housing portion including circuitry to enable communication with the digitizer panel,
the interface including an arrangement of multiple connectors connectable to an array of transmitters disposed in the tip portion, and
the tip portion configured as a brush with a plurality of flexible bristles to facilitate painting operations in conjunction with an application of the computing device and including the array of transmitters disposed in a three-dimensional arrangement across the plurality of flexible bristles to represent a three-dimensional shape of the brush.

19. A system as described in claim 18, wherein the stylus further comprises one or more one or more light emitting elements configured to selectively illuminate regions of the brush to visually represent colors of paint associated with the regions in connection with the painting operations.

20. A system as described in claim 18, wherein:
the stylus includes a multi-channel generator to generate signals conveyed via the interface to the tip portion for transmission through the array of transmitters; and
the computing device includes a stylus control module operable to detect and interpret the signals to resolve positions of the array of transmitters relative to the digitizer panel in three-dimensional space, and to control the painting operations in dependence upon the positions of the array of transmitters.
